(19) United States
(12) Patent Application Publication
(10) Pub. No.: US 2013/0053105 A1
(43) Pub. Date: Feb. 28, 2013

(54) APPARATUS AND METHOD FOR CONTROLLING LOCK MODE

(71) Applicants: Jae Ho LEE, Seoul (KR); Hun Hee KANG, Seoul (KR); Young Ju SUNG, Seoul (KR)

(72) Inventors: Jae Ho LEE, Seoul (KR); Hun Hee KANG, Seoul (KR); Young Ju SUNG, Seoul (KR)

(73) Assignee: PANTECH CO., LTD., Seoul (KR)

(21) Appl. No.: 13/530,988

(22) Filed: Jun. 22, 2012

(30) Foreign Application Priority Data
Aug. 26, 2011 (KR) 10-2011-0085917

(51) Int. Cl. H04W 88/02

(52) U.S. Cl. 455/565

(57) ABSTRACT

An apparatus includes: a display unit to display a first function icon and a second function icon associated with first-layer functions; an input unit to receive a first selection input corresponding to the first function icon, and to receive a first execution input in succession with the first selection input; and a controller to execute a first function associated with the first function icon, in response to the first execution input. The display unit displays a first sub-function icon by replacing the second function icon, in response to the first selection input, the first sub-function icon being associated with a sub-function of the first function.

### CROSS-REFERENCE TO RELATED APPLICATION

This application claims priority from and the benefit under 35 U.S.C. §119(a) of Korean Patent Application No. 10-2011-0085917, filed on Aug. 26, 2011, which is hereby incorporated by reference for all purposes as if fully set forth herein.

### BACKGROUND

Field

The following disclosure relates to an apparatus and method for controlling a lock mode, and more particularly, to an apparatus and method for controlling a lock mode of a terminal.

Discussion of the Background

As mobile terminals having a wide touch screen have emerged, terminal users is have been provided with the wide touch screen as a main user interface. However, since the size of the touch screen is wider, a user may make an unintended touch input more frequently while carrying or using the mobile terminal. For example, a specific functional icon may be inadvertently touched by a user and a function corresponding to the icon may be unintentionally executed as a result of the inadvertent touch.

To prevent the aforementioned problem, a terminal having a touch screen may have a lock mode. In the lock mode, a lock screen may be displayed on the terminal, and an input signal inputted through the touch screen may be processed when the lock mode is unlocked using an unlocking input method. Specifically, the lock screen may be displayed, instead of a standby screen, when a user touches the touch screen to use the terminal in a sleep mode.

However, it may be inconvenient for the user to unlock the lock screen to execute a frequently used function, since the user frequently views the lock screen while using the terminal.

### SUMMARY OF THE INVENTION

Exemplary embodiments of the present invention provide an apparatus and method for controlling a lock mode.

Additional features of the invention will be set forth in the description which follows, and in part will be apparent from the description, or may be learned by practice of the invention.

An exemplary embodiment of the present invention provides a mobile terminal, including a display unit to display a first-layer function icon associated with a first-layer function; an input unit to receive a first selection input corresponding to the first-layer function icon, and to receive a first execution input associated with the first selection input; and a controller to execute the first-layer function in response to the first execution input. The display unit displays a second-layer function icon in response to the first selection input, the second-layer function icon being associated with a second-layer function, and the second-layer function is a sub-function of the first layer function.

An exemplary embodiment of the present invention provides an apparatus, including a display unit to display a first function icon and a second function icon associated with first-layer functions; an input unit to receive a first selection input corresponding to the first function icon, and to receive a first execution input in succession with the first selection input; and a controller to execute a first function associated with the first function icon, in response to the first execution input. The display unit displays a first sub-function icon by replacing the second function icon, in response to the first selection input, the first sub-function icon being associated with a sub-function of the first function.

An exemplary embodiment of the present invention provides a method for managing functions in a lock mode, including displaying a first-layer function icon associated with a first-layer function; receiving a first selection input corresponding to the first-layer function icon; displaying a second-layer function icon in response to the first selection input; and executing, using a processor, the first-layer function in response to a receipt of a first execution input associated with the first selection input. The second-layer function icon is associated with a second-layer function, and the second-layer function is a sub-function of the first layer function.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a flowchart illustrating a method for controlling a lock mode according to an exemplary embodiment of the present invention.

FIG. 2 is a diagram illustrating lock screens according to an exemplary embodiment of the present invention.

FIG. 3 is a diagram illustrating a method for setting a lock mode according to an exemplary embodiment of the present invention.

FIG. 4 is a diagram illustrating a method for controlling a lock mode using a touch and drag motion according to an exemplary embodiment of the present invention.

FIG. 5A and FIG. 5B are diagram illustrating lock screens displayed based on a mode of a terminal according to an exemplary embodiment of the present invention.

FIG. 6A and FIG. 6B are diagrams illustrating lock screens displayed based on a time and/or a location according to an exemplary embodiment of the present invention.

FIG. 7 is a diagram illustrating a lock screen with a three-layer hierarchical structure according to an exemplary embodiment of the present invention.

FIG. 8 is a diagram illustrating a method for controlling a lock screen using a rotary motion according to an exemplary embodiment of the present invention.

FIG. 9 is a diagram illustrating a configuration of a lock mode control apparatus according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, XZZ, YZ, X).

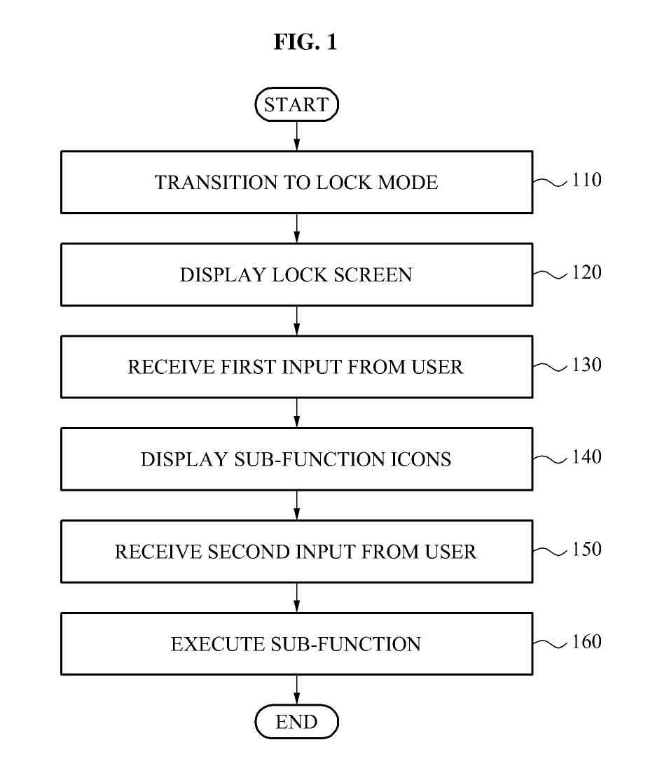

FIG. 1 is a flowchart illustrating a method for controlling a lock mode according to an exemplary embodiment of the present invention.

Referring to FIG. 1, in operation 110, a terminal may transition to a lock mode.

If the terminal transitions to the lock mode, a lock screen may be displayed on a display unit of the terminal in operation 120. The lock screen may refer to a screen displayed on the display unit during the lock mode. The lock screen may include a plurality of areas that display function icons corresponding to functions (“first layer functions”) of the terminal. Specifically, the function icons may be displayed on the plurality of areas of the lock screen, respectively.

The terminal may have functions, such as a dial function, a message function, a music function, a camera function, an Internet function, a setting function, and the like, and may include applications associated with the functions. Further, a function icon may represent an icon associated with a function.

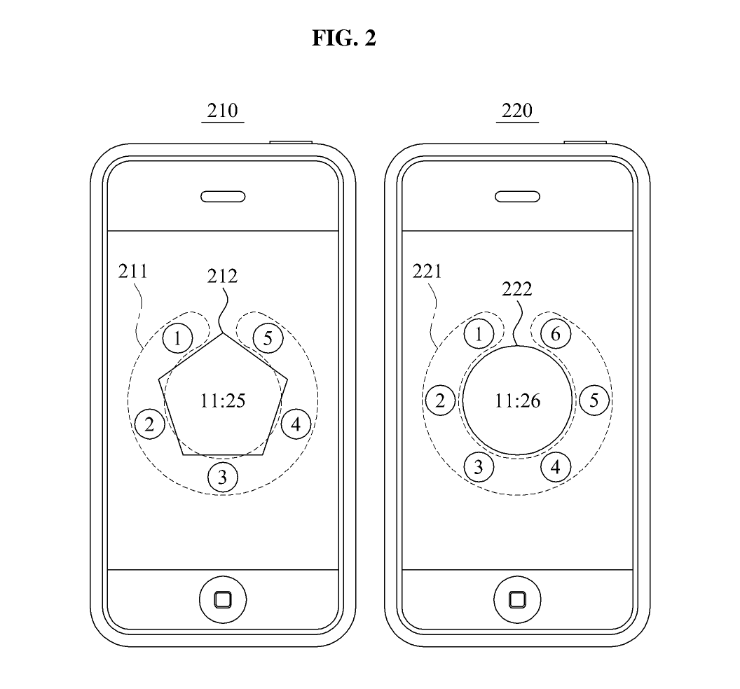

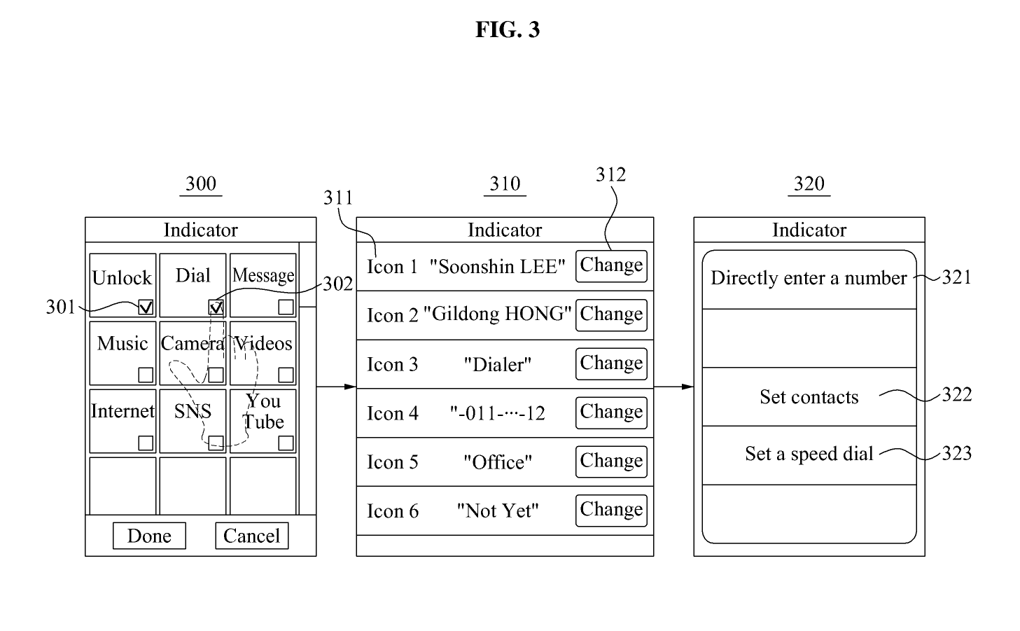

A user may set the lock screen, and set which function icons appear on the lock screen. A method for setting the lock screen and function icons will be described in more detail below with reference to FIG. 2 and FIG. 3.

If the lock screen is displayed on the display unit, the user may select a function icon among a plurality of function icons displayed on the lock screen, and may input a first input for the selected function icon to the terminal. For example, the user may select a function icon among function icons displayed on a touch screen of the terminal, for example, by touching the function icon, so that the first input may be input to the terminal. The first input may be received from the user to the terminal in operation 130. The first input may be inputted through at least one of a touch input, a motion input, and voice input. The motion input may be a movement of an object that may be sensed by a camera, an image sensor, a light sensor, or the like. The touch input and the voice input may be received by the touch screen and a voice recognition unit including a microphone, respectively.

If the first input is received, sub-function icons representing sub-functions (“second layer functions”) of the selected function corresponding to the first input may be displayed on the plurality of areas of the lock screen in operation 140. For example, if the user selects a dial function by inputting a first input for selecting the dial function, sub-function icons associated with sub-functions of the dial function may be displayed on the plurality of areas of the lock screen corresponding to the areas to display unselected function icons. The sub-functions of the dial function may include, for example, viewing a call log, deleting a call log, calling a contact ‘A,’ entering a contact number, and the like. Subsequently, the user may select a sub-function icon among the displayed sub-function icons by inputting a second input for selecting the selected sub-function icon to the terminal. For example, the user may select a sub-function icon representing a sub-function of calling the contact ‘A’ by touching the sub-function icon, so that the second input may be input to the terminal. The second input may be received from the user to the terminal in operation 150. The second input may be inputted through at least one of a drag scheme, a multi-touch scheme, a motion recognition scheme, and a voice recognition scheme. For example, the second input may be a drag input toward a sub-function to be selected in the drag scheme, the second input may be a multi-touch input corresponding to a sub-function icon to be selected while maintaining a first touch corresponding to the first input in the multi-touch scheme, the second input may be a motion input corresponding to a sub-function to be selected in the motion recognition scheme, and the second input may be a voice input corresponding to a sub-function to be selected in the voice recognition scheme. Further, sub-function icons may include pieces of database information. For example, the database information may include a telephone number, a speed dial number, a priority number of each piece of database information, call history information, account information, multimedia playlist, web-browsing history information, video/image list, audio file list, or the like. Thus, in response to the first input, pieces of database information may be displayed in a lock screen.

If the first input corresponds to an input to unlock the lock mode, the lock mode may be unlocked and a preset screen may be displayed. For example, if a user does not want to use a function and a sub-function of the function that are displayed on the lock screen, the user may directly input an unlocking signal to unlock the lock mode, and the preset screen may be displayed.

If the second input is received, the sub-function corresponding to the second input may be executed in operation 160. For example, if the user selects the sub-function icon representing the sub-function of calling the contact ‘A’ among the plurality of sub-function icons displayed on the lock screen by inputting the second input, the sub-function of calling the contact ‘A’ may be executed. Accordingly, the user may execute a sub-function in the lock screen without performing various steps including unlocking the lock mode, displaying a default screen, selecting a function icon, and selecting the sub-function icon.

A lower hierarchy sub-function, such as a third layer function that is a sub-function of the second layer functions, may be set, displayed, and selected, based on the higher hierarchy functions. In other words, functions may have a hierarchical structure having multiple layers. Further, sub-layer functions having a lower hierarchy than the first layer functions, such as the second layer functions, the third layer functions, fourth layer functions, and the like, may be set according to the complexity of hierarchy of the corresponding applications.

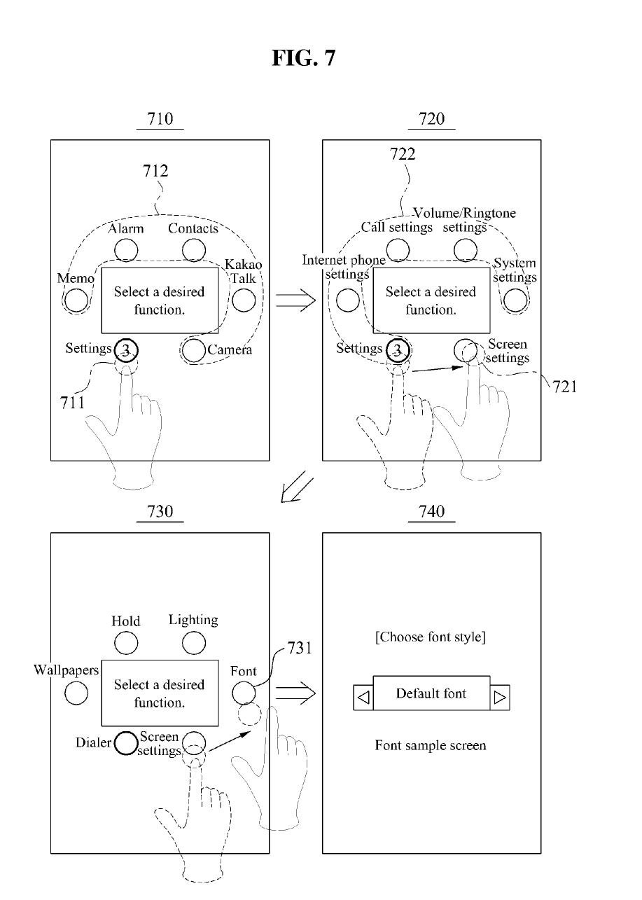

If the sub-function, the second layer function, corresponding to the second input includes a plurality of third layer functions, sub-layer function icons associated with the third layer functions, third layer function icons, may be displayed on the plurality of areas of the lock screen. Subsequently, the user may select a third layer function icon among the third layer function icons displayed on the lock screen by inputting a third input, or executing the second layer function without selecting the third layer function icon by inputting a fourth input. For example, if the user inputs a drag input toward the third layer icon before releasing the second input, the third layer function icon may be selected. If the user releases a touch input corresponding to the second input, the second layer function may be executed. Further, if the third input is received, a third layer function corresponding to the third input may be executed without waiting for further input if fourth layer functions are not preset or registered. The hierarchical structure will be described in detail below with reference to FIG. 7.

Hereinafter, a method for controlling lock mode and performing lock mode setting to control the lock mode will be described with reference to FIG. 2 and FIG. 3.

FIG. 2 is a diagram illustrating lock screens according to an exemplary embodiment of the present invention.

Referring to FIG. 2, a plurality of lock screens, for example, lock screens 210 and 220, may be provided. A user may select a lock screen among the plurality of lock screens. For example, the user may set and use the lock screen 210 including five function icons, or the lock screen 220 including six function icons. The function icons 211 and 221 may be referred to as first layer function icons.

Setting information associated with the lock mode may be received from a user. Further, a lock screen of the lock mode may be generated based on the received setting information. For example, if the user inputs ‘7’ for the number of the first layer function icons, a lock screen having seven function icons may be generated.

The lock screens 210 and 220 may respectively include icon display areas 211 and 221 on which function icons are displayed, and function execution areas 212 and 222 to which a selected function icon may be dragged to execute the function corresponding to the selected function icon. For example, if the user drags a function icon onto the function execution area 212 or 222, a function corresponding to the function icon may be executed. Further, the user may select and arrange function icons to be placed on the icon display areas 211 and 221.

The setting information may include at least one of information on function icons and sub-function icons that a user may select to display on a plurality of areas of a lock screen, information on the number of the plurality of areas corresponding to each function icon or each sub-function icon, information on positions of the plurality of areas corresponding to each function icon or each sub-function icon in the lock screen, and information on a method of receiving a first input or a second input.

For example, referring to FIG. 3, a setting screen 300 may be displayed. The setting screen 300 may enable a user to set one or more function icons to be placed on an icon display area, such as the icon display area 211 and 221. Specifically, function icons to be placed on the icon display area may be arranged on the setting screen 300. If a user determines to display a unlock function and a dial function on the icon display area, the user may select a selection box 301 for the unlock function and a selection box 302 for the dial function. Further, sequence of the selected functions may be changed by a user input. For example, the dial function, the unlock function, and a music function may be determined to be displayed on areas 1, 2, and 3 of the icon display area 211 and 221 of FIG. 2, respectively.

Further, a setting screen 310 may be displayed. The setting screen 310 may be used to set a sub-function icon of a selected function icon to be displayed on the icon display area. For example, if a user checks the selection box 302 for the dial function, sub-function icons of the dial function may be arranged. Accordingly, the user may select one or more sub-function icons to be displayed on the lock screen among the arranged sub-function icons.

To replace one or more sub-function icons with another sub-function icon or to change the sequence of the sub-function icons, the user may select a change button corresponding to the sub-function icon to be changed. Further, the user may drag a sub-function icon 311 to another location to change the sequence of the sub-function icons. Further, an item to change a sub-function icon may be provided. For example, if the user selects a change button 312 to change a function of ‘calling Soonshin LEE,’ an item 321 to directly enter a number, an item 322 to set contacts, an item 323 to set a speed dial, and the like, may be displayed on a screen 320 of a terminal. If the user selects the item 321, the function of Icon 1 311 may be changed from the function of ‘calling Soonshin LEE’ to the function of directly enter a number 321.

As described above, a user may be provided with setting screens 300, 310, and 320 that enable the user to set functions and sub-functions to be displayed on a lock screen. Thus, the user may select or change a function and/or a sub-function through the setting screen displayed on the terminal.

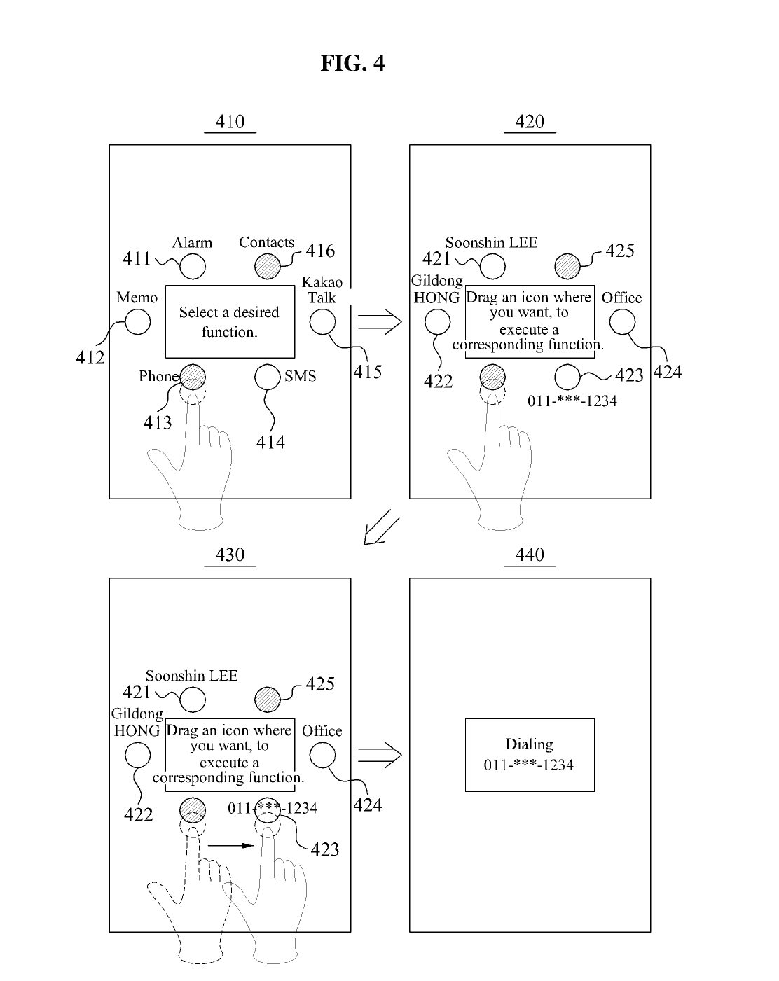

FIG. 4 is a diagram illustrating a method for controlling a lock mode using a touch and drag motion according to an exemplary embodiment of the present invention.

Referring to FIG. 4, during the lock mode, a lock screen including function icons may be displayed on a touch screen of the terminal, based on setting information associated with the lock mode set by a user. For example, if the user sets one or more function icons to be displayed on a lock screen 410, the lock screen 410 including the function icons may be displayed on the touch screen of the terminal. The function icons may include an alarm icon 411, a memo icon 412, a phone icon 413, an SMS icon 414, a KakaoTalk icon 415, and a contacts icon 416. The KakaoTalk icon 415 may represent an application ‘KakaoTalk’ enabling a phone number-based mobile messenger service.

If the user touches a function icon among the function icons displayed on the touch screen, the function icon may be selected. If the function icon is selected, sub-function icons associated with the selected function icon may be displayed on the areas where unselected function icons are placed other than the area on which the selected function icon is displayed.

For example, if the user selects the phone icon 413 by touching the phone icon 413, the phone icon 413 may be selected. In response to the selection of the phone icon 413, sub-function icons 421, 422, 423, and 424 may be displayed on the areas where the alarm icon 411, the memo icon 412, the SMS icon 414, and the Kakao Talk icon 415 are placed, respectively other than the area of the phone icon 413 in a lock screen 420. The sub-function icons 421, 422, 423, and 424 may be sub-functions of the function corresponding to the selected phone icon 413, and may be used to call ‘Soonshin LEE,’ ‘Gildong Hong,’ ‘011-***-1234,’ and the office, respectively. If the number of set sub-function icons is less than the number of areas occupied by unselected function icons, the available area 425 on which no sub-function icon is displayed may be included in the lock screen 420 or assigned to another sub-function based on a usage pattern of the user.

If the sub-function icons are displayed, the user may drag the function icon that is being touched to one of the displayed sub-function icons. If the dragging input is received, the sub-function corresponding to the sub-function icon to which the function icon is dragged may be executed.

For example, the user may drag the phone icon 413 to the icon 423 that is used to call ‘011-***-1234,’ on a lock screen 430. Accordingly, the lock mode of the terminal may be unlocked, the sub-function of ‘calling 011-***-1234’ may be executed, and a calling screen 440 may be displayed.

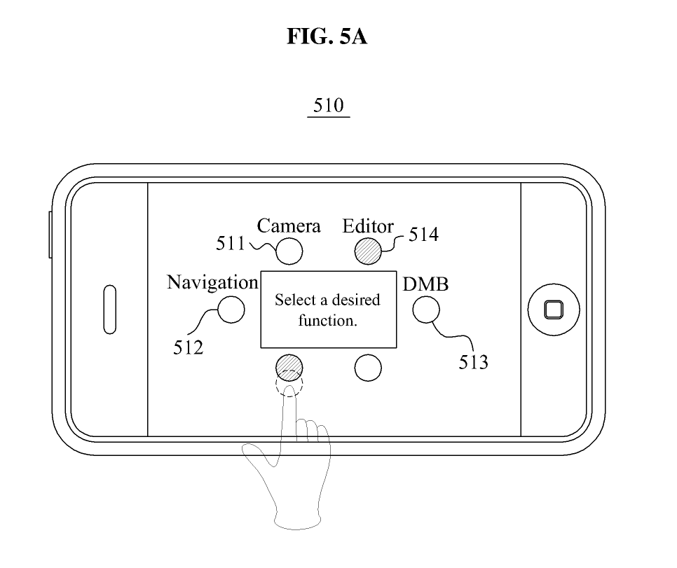

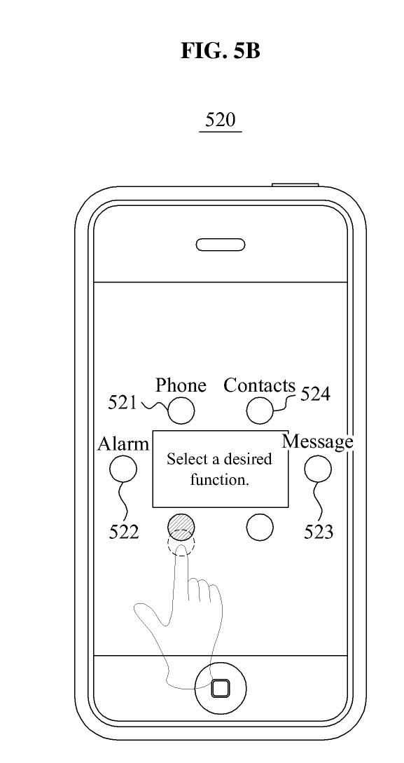

FIG. 5A and FIG. 5B are diagrams illustrating lock screens displayed based on a mode of a terminal according to an exemplary embodiment of the present invention.

Referring to FIG. 5A and FIG. 5B, different lock screens may be displayed on a display unit of the terminal, based on the mode of the terminal. Since a user may have a preference to perform certain functions in a landscape mode and may have a preference to perform other functions in a portrait mode, different lock screens may be displayed on the terminal based on the mode of the terminal. The landscape mode refers to a horizontal orientation of a terminal as shown in FIG. 5A, and the portrait mode refers to a vertical orientation of the terminal as shown in FIG. 5B. For example, a camera icon 511, a navigation icon 512, a digital multimedia broadcasting (DMB) icon 513, and an editor icon 514 may be displayed if the terminal is in the landscape mode, since a camera function, a navigation function, a DMB function, and an editing function may be more commonly performed in the landscape mode.

A user may set first setting information, and second setting information. The first setting information may be set for the lock mode of the portrait mode 520, and the second setting information may be set for the lock mode of the landscape mode 510. The terminal may determine the first setting information and the second setting information according to a user input.

For example, if the terminal is in the landscape mode 510 as shown in FIG. 5A, the user may set a camera icon 511, a navigation icon 512, a DMB icon 513, and an editor icon 514, as function icons to be displayed on the lock screen of the landscape mode 510. The icons 511, 512, 513, and 514 may be provided through a horizontally oriented screen for a user to execute corresponding functions. Further, if the terminal is in the portrait mode 520 as shown in FIG. 5B, the user may set a phone icon 521, an alarm icon 522, a message icon 523, and a contacts icon 524, as function icons to be displayed on the lock screen of the portrait mode 520. The icons 521, 522, 523, and 524 may be provided through a vertically oriented screen for a user to execute corresponding functions.

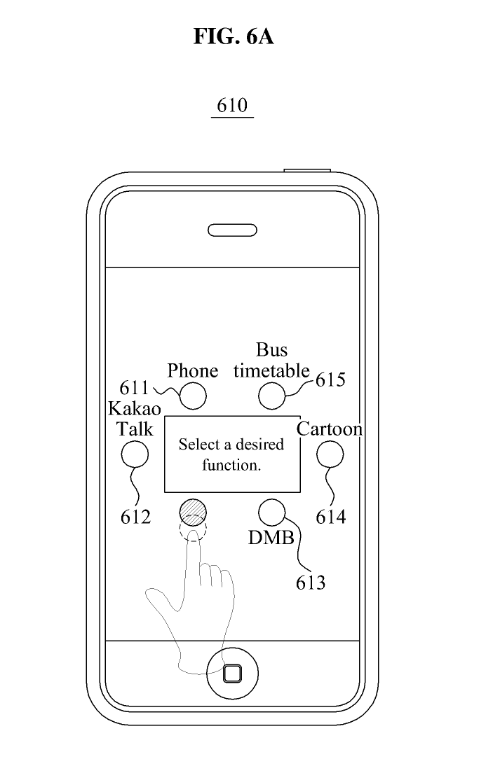

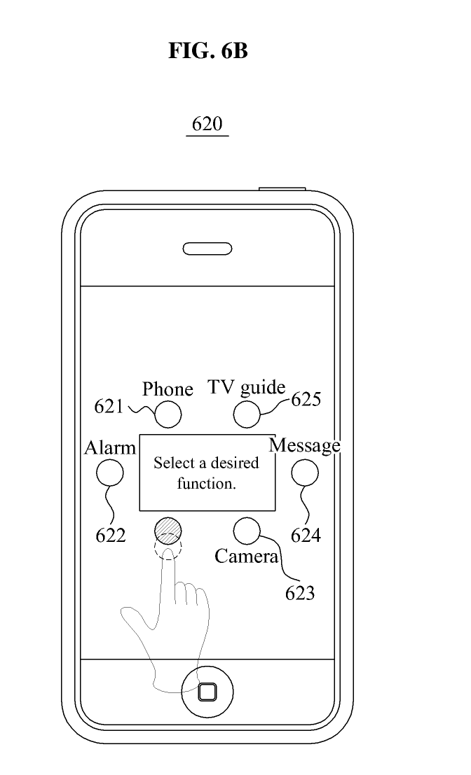

FIG. 6A and FIG. 6B are diagrams illustrating lock screens displayed based on a time and/or a location according to an exemplary embodiment of the present invention.

Referring to FIG. 6A and FIG. 6B, different lock screens may be displayed on a terminal, based on a time or a location of the terminal. Since frequently used functions may vary for each user depending on a time or a location of the terminal, different lock screens may be displayed on the terminal, based on the time or the location of the terminal.

A user may set a plurality of pieces of setting information for a location of the terminal. For example, if a function frequently used in a house differs from a function frequently used in an office, the user may input first setting information for the house and second setting information for the office. If the terminal is located in the house, the user may see the lock screen according to the first setting information. If the terminal is located in the office, the user may see the lock screen according to the second setting information. The terminal may receive the plurality of pieces of setting information from the user or accumulate terminal usage information to recognize a usage pattern and to generate setting information, based on the location of the terminal.

The location of the terminal may be tracked using global positioning system (GPS), wireless communication access point, or the like. Further, a lock screen may be generated based on setting information corresponding to the tracked location among the plurality of pieces of setting information. For example, if the terminal is determined to be located at a house inputted by the user, a lock screen may be generated based on setting information corresponding to the location of the house, and the generated lock screen may be displayed on the terminal.

The user may set a plurality of pieces of setting information based on a time. For example, functions frequently used during commuting hours may differ from functions frequently used during business hours, the user may input first setting information for the commuting hours, and input second setting information for the business hours. As shown in FIG. 6A, the user may set a phone icon 611, a KakaoTalk icon 612, a DMB icon 613, a cartoon icon 614, and a bus timetable icon 615, as function icons to be displayed on a lock screen 610 during the commuting hours. As shown in FIG. 6B, the user may set a phone icon 621, an alarm icon 622, a camera icon 623, a message icon 624, and a TV guide icon 625 as function icons to be displayed on a lock screen 620 during the business hours. The terminal may receive the plurality of pieces of setting information from the user based on the time information. Further, the setting information may be generated automatically according to usage time pattern of the terminal.

A lock screen may be displayed based on setting information corresponding to a current time among the plurality of pieces of setting information. For example, if the current time is within the commuting hours inputted by the user or determined by the usage time pattern, a lock screen may be displayed based on setting information corresponding to the commuting hours.

FIG. 7 is a diagram illustrating a lock screen with a three-layer hierarchical structure according to an exemplary embodiment of the present invention.

Referring to FIG. 7, if a function includes multiple layer sub-functions hierarchically, a lock screen may be hierarchically controlled.

A lock screen 710 may be displayed on a terminal, based on setting information. The lock screen 710 may include first layer function icons, such as an alarm icon, a memo icon, a setting icon, a camera icon, a KakaoTalk icon, and a contacts icon. For example, if the user selects the ‘settings’ icon representing a setting function of the terminal by touching the area 711 on which the ‘settings’ icon is displayed, second layer function icons representing sub-functions of the setting function may be displayed on the area 712 other than the area 711 as shown in the lock screen 720. The second layer function icons may include a ‘screen settings’ icon, a ‘system settings’ icon, a ‘call settings’ icon, a ‘volume/ringtone settings’ icon, and an ‘Internet phone settings’ icon, and the second layer function icons may be displayed as sub-function icons representing sub-functions of the setting function, on a lock screen 720 of the terminal. For example, if the user touches the area 711 and holds the touch (“first selection input”), second layer function icons may be displayed on the area 712. If the user releases the touch on the area 711 without further input, the second layer function icons may be replaced back by the first layer function icons as shown in the lock screen 710. On the other hand, if the user drags the touch input from the area 711 to the center region without releasing the touch (“first execution input”), the selected first layer function 711 may be executed and the lock mode may be unlocked. If the user drags the touch input to the icon 721 without releasing the touch (“second selection input”), the ‘screen settings’ sub-function may be selected and third layer function icons may be displayed on the area including 731 as shown in the lock screen 730. If the user drags the touch input from the area 721 to the center region without releasing the touch (“second execution input”), the selected second layer function 721 ‘screen settings’ may be executed and the lock mode may be unlocked. If the user drags the touch input from the screen setting 721 to the icon 731 without releasing the touch (“third selection input”), the ‘font’ sub-function may be selected.

If fourth layer function icons for the ‘font’ sub-function do not exist, the ‘font’ function may be executed by the selection, but is not limited as such. The drag input to a sub-function icon, the release of the touch, the drag input to the center region may be a selection of the sub-function, a return to the default lock screen, an execution of the selected function or sub-function, respectively.

In an example, the user may select the ‘screen settings’ icon from the lock screen 720, by dragging the ‘settings’ icon to the area 721 on which the ‘screen settings’ icon is displayed.

Third layer function icons representing sub-functions of a screen setting function may be displayed on the area 722 other than the area 721. For example, a ‘hold’ icon, a ‘wallpaper’ icon, a ‘dialer’ icon, a ‘font’ icon, and a ‘lighting’ icon may be displayed as the third layer function icons of the screen setting function on a lock screen 730.

If the user desires to change a font style of the terminal, the user may drag the ‘screen settings’ icon to the area 731 on which the ‘font’ icon is displayed. The lock mode may be unlocked, and a function corresponding to the ‘font’ icon may be executed on a screen 740. Further, an execution of a first layer icon, a second layer icon, or a third layer icon may be performed if a corresponding icon is dragged into the center region of the screens 710, 720, and 730. For example, if the touch input is dragged into the center region of the screen 720 from the area 721 on which the ‘screen settings’ icon is displayed, the screen setting function may be executed. Further, the execution of the first layer icon, the second layer icon, or the third layer icon may be performed if the touch input is released from the corresponding icon. For example, if the touch input is released when the touch input is located at the area 731 on which the ‘font’ icon is displayed, the font function may be executed.

Although not shown in FIG. 7, fourth layer or higher layer function icons may be displayed on a lock screen, if a specific function has at least three hierarchical structures.

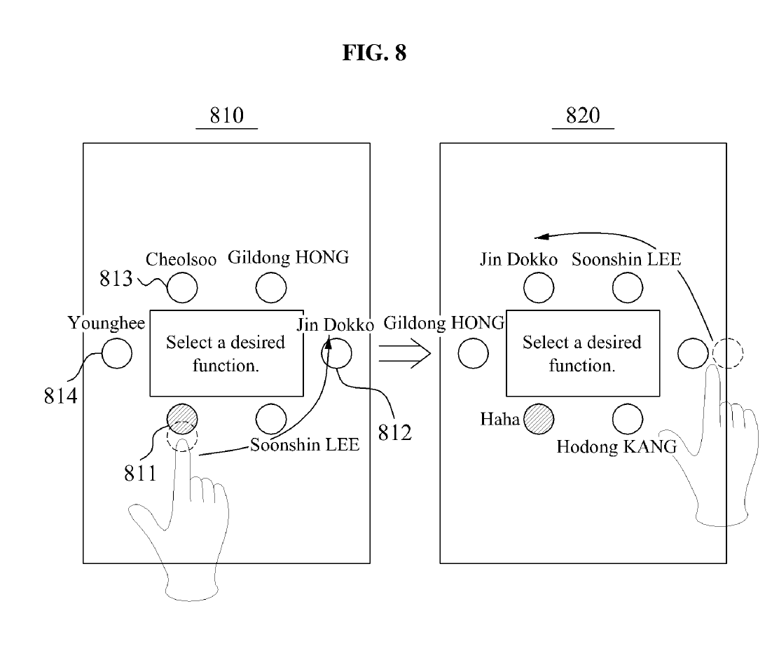

FIG. 8 is a diagram illustrating a method for controlling a lock screen using a rotary motion according to an exemplary embodiment of the present invention.

Referring to FIG. 8, sub-functions of a selected function may be displayed on a terminal using the rotary scheme.

For example, when a user touches an icon 811 representing a phone function displayed on a lock screen 810, icons 812, 813, and 814 representing sub-functions of the phone function may be displayed on the lock screen 810. The icons 812, 813, and 814 may be used to call ‘Jin Dokko,’ ‘Cheolsoo,’ and ‘Younghee,’ respectively.

If a target or phone number, the user desires to call, is not displayed on the lock screen 810, the user may drag the icon 811 that is being touched, while rotating the icon 811 clockwise or counterclockwise. Subsequently, a plurality of sub-function icons that are set may be sequentially displayed on a lock screen 820 in a prioritized order, if the icon 811 is dragged to the exterior of the next icon as shown in the screen 820. The icons 813 and 814 may disappear from the screen 820 and new icons corresponding to ‘Hodong KANG’ and ‘Haha’ may be displayed on the screen 820. Alternatively, the icon 811 may be rotationally dragged around the initial location of the icon 811 to rotate the list of the plurality of sub-function icons.

For example, the user may manipulate and select sequentially arranged icons associated with sub-functions of calling ‘Younghee,’ ‘Cheolsoo,’ ‘Gildong Hong,’ ‘Jin Dokko,’ ‘Soonshin LEE,’ ‘Hodong KANG,’ and ‘Haha.’ The selected icons may be sequentially displayed on the lock screen. If the user drags the icon 811 to the icon 812, the icons 814 and 813, each having a first priority and a second priority, may disappear, and icons representing sub-functions of calling ‘Hodong KANG,’ and ‘Haha’ may appear on the lock screen 820, since the touch input is dragged from the area 811 to the exterior side of the area 812 corresponding to two icon rotations. Further, if a drag input is used for rotating icons, a multi-touch input may be used for selecting a target icon, for example.

As described above, sub-function icons representing sub-functions of a selected function may be displayed on a lock screen using a rotary motion, and thus a user may enable a desired sub-function icon to be displayed on the lock screen, even though the number of areas on which the sub-function icons are displayed is limited.

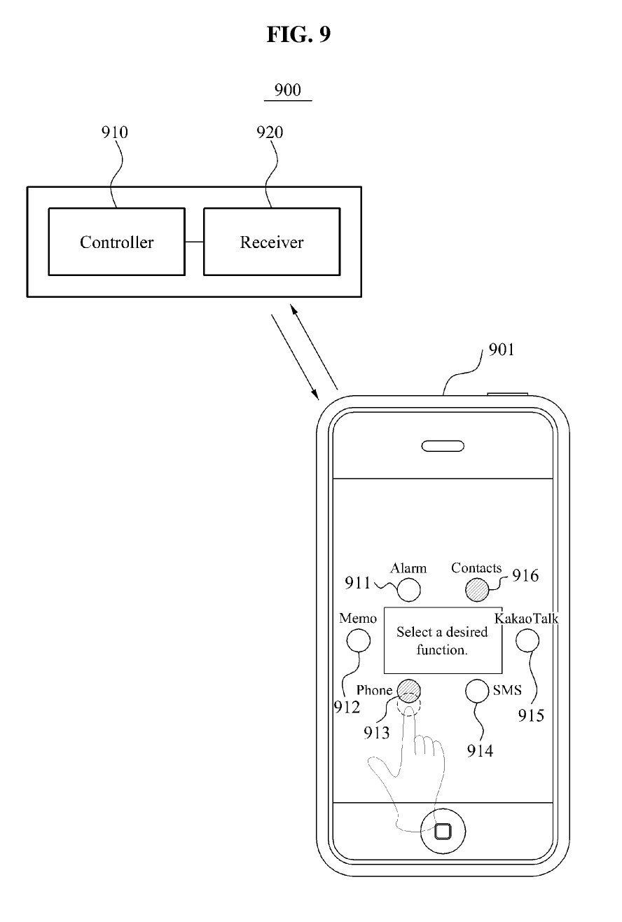

FIG. 9 is a diagram illustrating a configuration of a lock mode control apparatus according to an exemplary embodiment of the present invention.

Referring to FIG. 9, the lock mode control apparatus 900 may include a controller 910 and a receiver 920. The lock mode control apparatus 900 may be included as a module of a terminal 901.

If the terminal 901 transitions to the lock mode, the controller 910 may display a lock screen on a display unit of the terminal 901. The lock screen may refer to a screen displayed on the display unit in the lock mode. The lock screen may include a plurality of areas that display function icons 911, 912, 913, 914, 915, and 916 representing functions of the terminal 901. In other words, the function icons 911, 912, 913, 914, 915, and 916 may be respectively displayed on the plurality of areas of the lock screen.

For example, the controller 910 may display, on the terminal 901, a lock screen including function icons, such as an alarm icon 911, a memo icon 912, a phone icon 913, an SMS icon 914, a KakaoTalk icon 915, and a contacts icon 916.

A user may set a lock screen, and set function icons to be displayed on the lock screen.

If the lock screen is displayed on the display unit, the user may select a function icon among a plurality of function icons displayed on the lock screen by inputting a first input for the function icon. For example, the user may select a function icon 913 among function icons displayed on a touch screen of the terminal 901 by touching the function icon 913. The receiver 920 may receive the first input inputted to the terminal 901. The first input may be inputted through at least one of the touch scheme, the motion recognition scheme, and the voice recognition scheme described above.

If the first input is received, sub-function icons representing sub-functions of the function corresponding to the first input may be displayed on the plurality of areas of the lock screen. For example, if the user selects a dial function and inputs a first input for the dial function, sub-function icons representing sub-functions of the dial function may be displayed on the plurality of areas of the lock screen. The sub-functions of the dial function may include, for example, viewing a call log, deleting a call log, calling a contact ‘A,’ entering a contact number, and the like. Subsequently, the user may select a sub-function icon among the displayed sub-function icons, and may input a second input for selecting the sub-function icon to the terminal 901. For example, the user may select a sub-function icon representing a sub-function of calling ‘A’ by touching the sub-function icon. The receiver 920 may receive the second input inputted to the terminal 901. The second input may be inputted through at least one of a drag scheme, a multi-touch scheme, a motion recognition scheme, and a voice recognition scheme described above.

If the first input corresponds to an input to unlock the lock mode, the controller 910 may unlock the lock mode. For example, if a user does not want to use a function and a sub-function of the function that are displayed on the lock screen, the user may directly input an unlocking input to unlock the lock mode, and the controller 910 may unlock the lock mode in response to the unlocking input. For example, a hardware key button disposed on the terminal may be pushed to unlock the lock mode.

If the second input is received, the sub-function corresponding to the second input may be executed. For example, if the user selects the sub-function icon representing the sub-function of calling ‘A’ among the plurality of sub-function icons displayed on the lock screen by inputting the second input, the controller 910 may execute the sub-function of calling ‘A.’ Accordingly, the user may simultaneously unlock the lock mode and execute a desired function, without inputting multiple inputs to execute the desired function after disabling the lock mode.

A lower hierarchy sub-function, such as a third layer function that is a sub-function of the second layer functions, may be set, displayed, and selected, based on the higher hierarchy functions. In other words, functions may have a hierarchical structure having multiple layers.

If the sub-function corresponding to the second input includes a plurality of third layer functions, the controller 910 may display third layer function icons representing the third layer functions on the plurality of areas of the lock screen, rather than executing the sub-function corresponding to the second input. Subsequently, the user may select a third layer function icon among the third layer function icons displayed on the lock screen by inputting a third input. Further, the receiver 920 may receive the third input, and the controller 910 may execute a third layer function corresponding to the third input.

The exemplary embodiments according to the present invention may be recorded in non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a display unit to display a first-layer function icon associated with a first-layer function;
an input unit to receive a first selection input corresponding to the first-layer function icon, and to receive a first execution input associated with the first selection input; and
a controller to execute the first-layer function in response to the first execution input,
wherein the display unit displays a second-layer function icon in response to the first selection input, the second-layer function icon being associated with a second-layer function, and the second-layer function is a sub-function of the first layer function.

2. The mobile terminal of claim 1, wherein the input unit receives a second selection input, and
the controller selects the second-layer function icon in response to the second selection input, the second selection input received after the first selection input.

3. The mobile terminal of claim 2, wherein the controller executes the second-layer function in response to a second execution input, the second execution input being associated with the second selection input.

4. The mobile terminal of claim 1, wherein the display unit displays the first-layer function icon during a lock mode, and the lock mode is unlocked if the first execution input is received in succession with the first selection input.

5. The mobile terminal of claim 3, wherein the first selection input is a first touch input corresponding to the first-layer function icon,
the first execution input is a first drag input from the first touch input,
the second selection input is a second drag input from the first touch input toward the second-layer function icon or a multi-touch input to the second-layer function icon, and
the second execution input is a third drag input from the second selection input or a release of the second selection input.

6. The mobile terminal of claim 2, wherein the display unit displays the second-layer function icon on an area corresponding to an unselected first-layer function icon, and
the display unit displays the unselected first-layer function icon by replacing the second-layer function icon if the first selection input is terminated without receiving the first execution input or the second selection input.

7. The mobile terminal of claim 1, wherein the display unit displays an execution region, and
the controller executes the first-layer function if the first execution input is received in the execution region.

8. The mobile terminal of claim 1, wherein the controller determines a type of the first-layer function icon based on a mode of the mobile terminal or state information of the mobile terminal.

9. The mobile terminal of claim 8, wherein the mode of the mobile terminal comprises a landscape mode or a portrait mode.

10. The mobile terminal of claim 8, wherein the state information of the mobile terminal comprises at least one of time information and location information of the mobile terminal.

11. The mobile terminal of claim 2, wherein the display unit displays a third-layer function icon in response to the second selection input, the third-layer function icon being associated with a third-layer function, and the third-layer function is a sub-function of the second layer function.

12. The mobile terminal of claim 1, wherein the input unit receives a first rotational input in succession with the first selection input, and
the display unit rotates a display position of the first-layer function icon and displays a lower priority first-layer function icon in response to the first rotational input.

13. An apparatus, comprising:
a display unit to display a first function icon and a second function icon associated with first-layer functions;
an input unit to receive a first selection input corresponding to the first function icon, and to receive a first execution input in succession with the first selection input; and
a controller to execute a first function associated with the first function icon in response to the first execution input,
wherein the display unit displays a first sub-function icon by replacing the second function icon in response to the first selection input, the first sub-function icon being associated with a sub-function of the first function.

14. A method for managing functions in a lock mode, comprising:
displaying a first-layer function icon associated with a first-layer function;
receiving a first selection input corresponding to the first-layer function icon;
displaying a second-layer function icon in response to the first selection input; and
executing, using a processor, the first-layer function in response to a receipt of a first execution input associated with the first selection input,
wherein the second-layer function icon is associated with a second-layer function, and the second-layer function is a sub-function of the first layer function.

15. The method of claim 14, further comprising:
receiving a second selection input;
selecting the second-layer function icon in response to the second selection input, the second selection input received after the first selection input; and
executing the second-layer function in response to a second execution input, the second execution input being associated with the second selection input.

16. The method of claim 14, further comprising unlocking the lock mode if the first execution input is received in succession with the first selection input,
wherein the first execution input is received during the lock mode.

17. The method of claim 15, wherein the first selection input is a first touch input corresponding to the first-layer function icon,
the first execution input is a first drag input from the first touch input,
the second selection input is a second drag input from the first touch input toward the second-layer function icon or a multi-touch input to the second-layer function icon, and
the second execution input is a third drag input from the second selection input or a release of the second selection input.

18. The method of claim 15, wherein the second-layer function icon is displayed on an area corresponding to an unselected first-layer function icon, and
the unselected first-layer function icon replaces the second-layer function icon if the first selection input is terminated without receiving the first execution input or the second selection input.

19. The method of claim 14, further comprising:
displaying an execution region; and
executing the first-layer function if the first execution input is received in the execution region.

20. The method of claim 14, further comprising determining a type of the first-layer function icon based on a mode of the mobile terminal or state information of the mobile terminal.
